(19) United States
(12) Patent Application Publication
(10) Pub. No.: US 2007/0219819 A1
(43) Pub. Date: Sep. 20, 2007

(54) Method and system for detecting title fraud

(75) Inventors: Julie L. Campbell, Wilmette, IL (US); Michael D. Poulos, Evanston, IL (US)

Correspondence Address: GREER, BURNS & CRAIN, 300 S WACKER DR, 25TH FLOOR, CHICAGO, IL, 60606, US

(73) Assignee: Title Insurance National Information Exchange LLC

(21) Appl. No.: 11/717,843

(22) Filed: Mar. 14, 2007

Related U.S. Application Data
(60) Provisional application No. 60/782,129, filed on Mar. 14, 2006.

(51) Int. Cl. G06Q 10/00; G06Q 30/00

(52) U.S. Cl. 705/1

(57) ABSTRACT

A method of detecting title fraud utilizes an electronic database in which is stored information relating to one or more title transactions. Such information includes common addresses of real estate properties, and at least one of a type of title transaction involved, and identifying indicia of parties to the title transactions. The method initiates a title order to a settlement agent for a new title transaction involving settlement services relating to a particular real estate property, and then searches the database for at least one other title transaction involving the same particular property, parties, or other indicia in common with said title order, and for any copendency during a period between the title order initiation and subsequent registration and indexing of the title transaction after the title transaction is completed. The method then reports whether or not a copending title transactions exists and, if so, the nature of, and available information relating to, the copending title transaction

### FIELD OF THE INVENTION

The present invention relates generally to the field of title fraud prevention. Embodiments of the present invention relate more specifically to a method and system to reduce title fraud, title insurance fraud, and mortgage fraud through an electronic communications system, or Internet-based website, to be used primarily by title agents.

### BACKGROUND

In 2004, fraud cost the title insurance and mortgage industries $429 million according to the United States Federal Bureau of Investigation. Some systems have been created to address the potential fraud in the mortgage application. One such conventional system is presented in U.S. Patent Application No. 2002/0133371 to Cole, as illustrated in FIG. 1.

The conventional system attempts to identify potential conflicts in the mortgage application process. Even approved mortgage applications under this system must still be recorded or registered and indexed by a title agent before another title agent, or lender outside of the particular system, can find evidence of the loan. (Note: the terms “record” and “recorded” are used to refer to registration of title documents with a relevant government office; “registration” though, as used below, refers to registration of pending transactions or title orders with the database called for by the present invention.) The type of fraud that the conventional system seeks to prevent can still occur during the time delay between the time of the initiation of the mortgage application, and the time at which the subsequently approved loan is closed and recorded by a title agent. More instances of fraud, however, can occur undetected during the delay between the time the loan is recorded, and the time the recorded loan is indexed.

A further drawback to the conventional system is that it only affects real estate transactions that involved a loan secured by the real estate, and the information in the system's database is collected primarily from the mortgage applications. Not all title transactions for real property include a mortgage. An easement on a real property is one example of a title transaction that does not require a mortgage to affect the value of the property. A straight cash sale of a property, with no mortgage involved, will not likely be included in the conventional system's database, except only as part of a property's historical market activity, and even then only after the cash sale has been recorded and indexed after the gap period. The conventional system will be unable to detect fraud related to two or more copending title transactions where only one (or none) involves a mortgage application.

The process of ordering, recording, and indexing title transactions is therefore a very separate and distinct process from the mortgage application process, although the title transaction process typically runs parallel with the mortgage application process. The two processes ideally merge at a successful closing of a mortgage application, but no such merger can occur when a mortgage does not exist, or is unrelated to a pending title transaction. Title fraud, title insurance fraud, and mortgage fraud thus involve many of the same factors, and the term “mortgage fraud” is commonly used in the art to refer to all such instances, even though actual title fraud is significantly different from what would be “pure” mortgage fraud, as detailed further below. Nevertheless, many of the losses associated with mortgage fraud and pure mortgage fraud are actually borne primarily by the title insurance industry, and not the mortgage lenders themselves.

Accordingly, there is a compelling need to reduce or prevent the fraud that can occur during the delays in having a title transaction registered and indexed, and the fraud that can occur from copending title transactions that involve only a single mortgage application at a time, or no mortgage at all.

### INVENTION SUMMARY

The present invention addresses the above-identified need by focusing on the title transaction process, instead of the conventional mortgage application process. By registering pending title transactions, users of the present invention, and/or subscribers to a system according to the present invention, can be alerted on a timely basis to potentially fraudulent schemes affecting title, including such instances of: double sales of the same real property; home equity line of credit (“HELOC”) scams; “flips” (described further below); and other similar schemes known in the art. The present invention is capable of searching for two or more copending title transactions on a same parcel of real estate, by the same parties, or involving other common indicia that can directly affect title. Affected users and/or subscribers can be alerted when matches are found within the database, and appropriate action can then be taken, if necessary.

### BRIEF DESCRIPTION OF THE DRAWINGS

FIG. 1 is a block diagram of a conventional mortgage fraud detection method.

FIG. 2 illustrates the relationship between a preferred embodiment of the present title fraud detection and prevention system, and subscribers to the system.

FIG. 3 is a block diagram of a preferred embodiment of the method of the present invention.

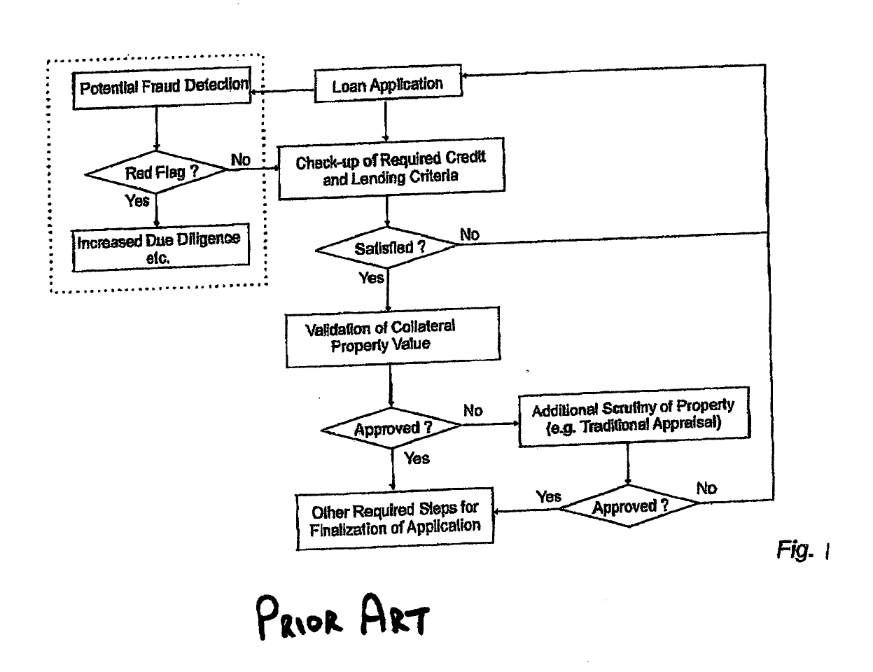

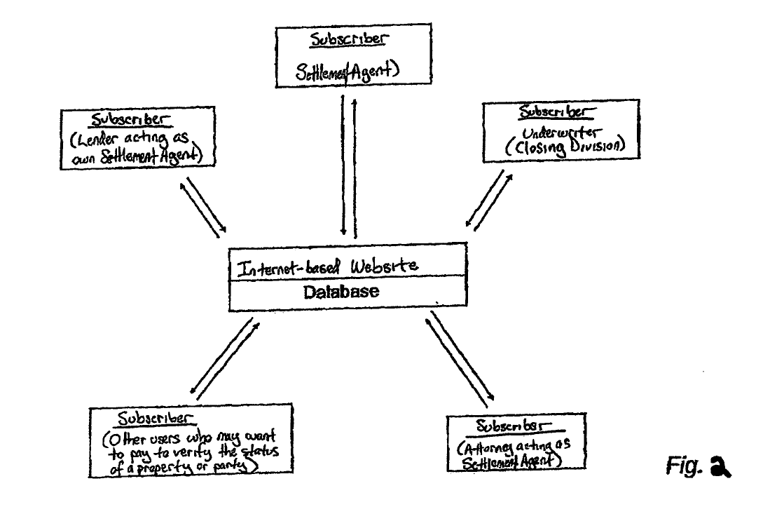

### INVENTION DESCRIPTION

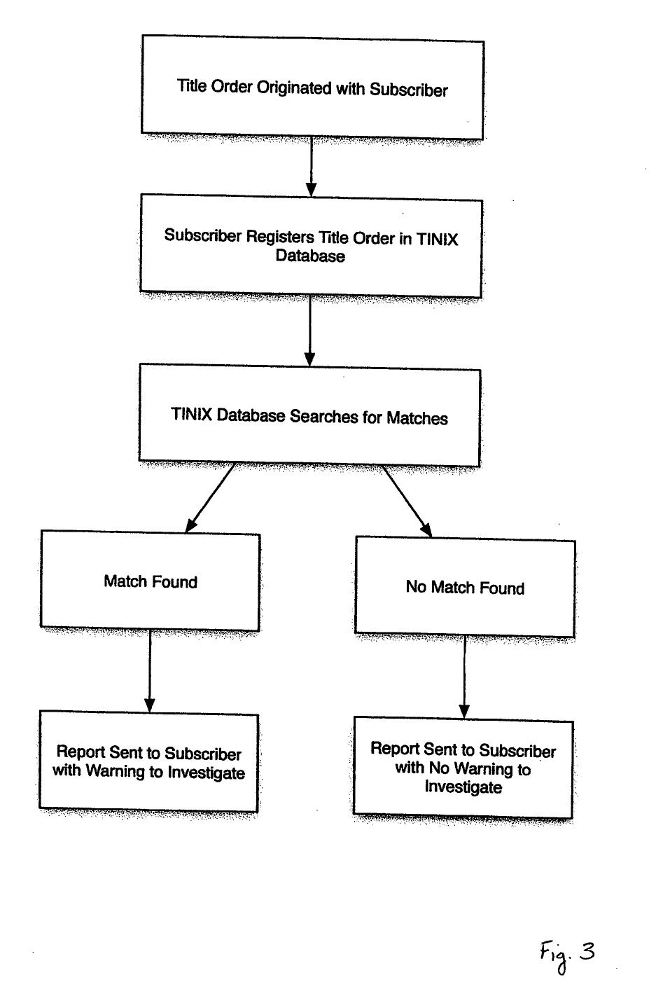

FIG. 2 shows a fraud detection system according to a preferred embodiment of the present invention. The system is preferably internet-based, where remote subscribers can directly access a website that interfaces with a fraud detection database. The website would be used and/or subscribed to primarily by title agents, but would also be useful to any party who uses, settles, or processes title transactions. Although an internet-based system is preferred, other known electronic database subscriber networks known in the art can be used, including, but not limited to, local area networks and dial-up subscriber networks.

A title transaction is typically any transaction involving settlement services in connection with real estate. Settlement services may include, but are not limited to, title searches, title examinations, provision of title certificates, preparation of title commitments, issuance of title insurance policies in the name of an underwriter, attorney services, document preparation, closing or settlement, and any other services for which a settlement service provider requires a party to the transaction to pay. An underwriter can be any company that issues, or in whose name is issued, title insurance policies.

Two or more copending title transactions on a single real estate parcel can be an indicator of potential mortgage fraud. The database therefore has a primary function to identify such multiple transactions that are simultaneously pending. The system of the present invention will preferably have Settlement Agents subscribe to the website. Settlement Agents can typically be a Closing Division, which is a division, subsidiary, department, or other unit of an underwriter authorized to conduct settlement services, or a Title Agent, which is separate entity or person authorized by an underwriter to conduct settlement services. A Settlement Agent can also be a lender, mortgagor, or other party entering into a real estate transaction without obtaining title insurance and conducting its own settlement services. In such cases, the settlement services actually performed by the lender may be related to a mortgage application process, but will still be separate functions from the mortgage application process itself, and only coincidentally performed by the same party for financial or other reasons.

A subscriber to the present system will input various information regarding a title transaction into the database through the website interface. The information to be input is typically initiated by a Title Order, which can be any pending transaction involving settlement services, being submitted to a Settlement Agent subscriber. A Title Order may include a loan transaction secured by real estate even if no title insurance is involved but, as described above, a Title Order need not be related to a loan transaction.

When the Settlement Agent receives the Title Order, the Settlement Agent will ideally enter information regarding the Title Order into the database in a timely manner, and will also update the information as needed. This information may includes all or some of the following:

a. Name of Title Agent.

b. Name of underwriter.

c. A Title Order number.

d. Type of title transaction involved, such as a cash sale, easement, partition or sub-division, mortgage, articles of agreement, refinance, home equity line of credit, bridge loan, etc.

e. Name(s) of purchasers/buyers/borrowers, and sale price, if the title transaction involves a sale.

g. Name(s) of lenders if the title transaction involves one or more loans to be secured by the real estate.

h. An amount of any loan connected with a title transaction.

i. The common address of the real estate, which will be preferably input in such a way that, if there is more than one common address, all such will be registered.

j. The property identification number (“PIN”) for the real estate, which will also be preferably input in such a way that all such PIN's will be registered if there is more than one.

k. The legal description of the real estate.

The Settlement Agent may also input additional information concerning the parties involved in the title transaction, including some or all of the following:

a. Party names.

b. Social Security numbers.

c. Drivers license numbers.

d. Residential addresses.

e. Business addresses.

f. Descriptive information, such as that appearing on a driver's license.

g. An image of the driver's license.

h. A photograph of each party.

i. A fingerprint of each party such as that used for computer security.

j. The name and license number of an appraiser of the real estate, and any identifying number used by the appraiser to identify the appraisal.

Individuals and/or businesses that suspect, or have been subjected to, identity theft may also voluntarily register any of the above identification information in the database. Such individuals and businesses may also subscribe to the website for a fee, or under any other terms agreed to with the website owner or operator. Similarly, Appraisers may voluntarily register appraisals they have actually performed into the database, including the appraised value of particular real estate properties, and Title Agents, underwriters, and law enforcement authorities may register the names, or other identifying information, of individuals and businesses that have been identified as having been involved in Title Insurance Fraud or Mortgage Fraud.

A Settlement Agent will preferably update the original registration of a Title Order or transaction as additional information is obtained. In a preferred embodiment, to facilitate registration, software used by the Settlement Agent to process Title Orders can be modified to automatically upload the registration information to the website, and thus the database, via a text file. In a more preferred embodiment, the Settlement Agent will be sent an email confirmation containing the registered information upon each registration of a Title Order or transaction, or an update of an existing registration.

In a preferred embodiment of the present invention, each time a Title Order is registered or updated, an electronic processor connected to, or integral with, the database will search the database for matching information on copending transactions. In a more preferred embodiment, all identifying information in the database will have its own identifier identifying when the information was first registered or ordered. In one embodiment of the invention, such information can be deleted from the database after the later of a specific time period has elapsed from the date of registration, such as two years, or the title transaction relating to that particular piece of information has been registered and indexed. The specific time period, however, can vary so as to be able to produce the greatest number of matches indicating potential fraud, but still limit the amount of false positives.

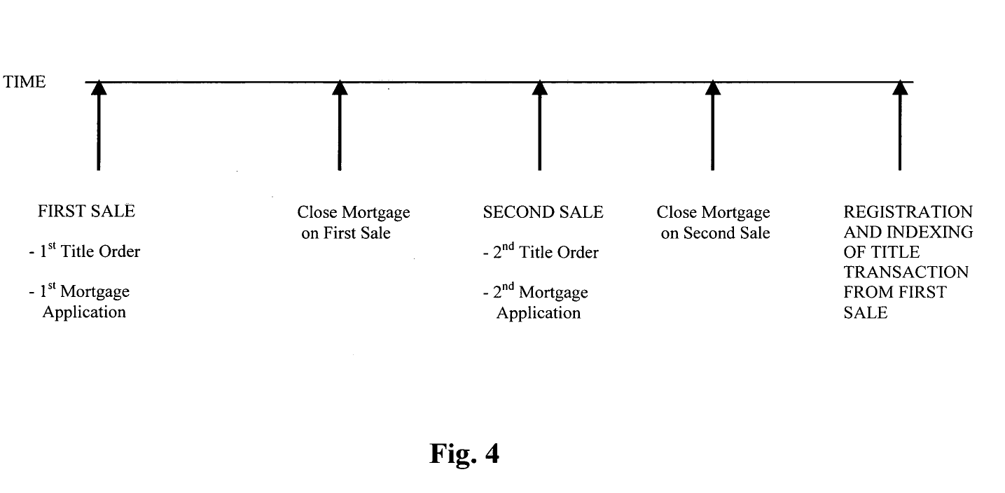

As can be seen in FIG. 3, when a match is found a notice is sent to all subscribers (Settlement Agents, Title Agents, underwriters, etc.) involved in any of the matching registrations. The notice will preferably set forth the information as to each registration and contact information for the affected subscribers or entities contributing to the database information. The matching information can thus be investigated so that it can be determined if possible Mortgage or Title Insurance Fraud is involved. When fraud is indicated by such investigation, appropriate action can be taken to avoid financial loss, and to contact the relevant law enforcement officials. The present inventors envision that the present system and method may also identify matching information that may not involve two copending title transactions, such as might occur with a stolen identity, a suspect name, suspect identification documents, or an unregistered appraisal from a participating appraiser, for example. In such cases, affected subscribers would still preferably receive an alert, and appropriate investigations and actions can still be performed to avoid fraud.

In yet another preferred embodiment, a subscriber may enter the website and obtain a report of matches regarding a particular Title Order. The Settlement Agent will be preferably encouraged to obtain such reports immediately prior to finishing the closing or settlement on the title transaction, and will be sent regular and/or timely email reminders to do in a preferred embodiment.

One notable feature of the present invention is its ability to reduce exposure to gap losses. Typically, when a document affecting title is recorded, there will be a period of up to several weeks for the recording to appear in the recorder's office index. A title search for a given transaction is known to only cover recorded transactions that have actually been indexed as of the date of the title search. Many title transactions may have already been recorded prior to this certain date, yet may not yet appear in the recorder's index. Such recorded-but-not-indexed transactions/documents will not appear in the title search results, yet will defeat the delivery of good and merchantable title. Other title transactions may be recorded at any time before the documents for the subject transaction are recorded. Again, those transactions will defeat the delivery of good and merchantable title. This phenomenon is at times referred to as the “race to the courthouse” because documents recorded first often have priority over documents recorded later.

The present invention can be particularly effective to reduce or eliminate the gap losses by informing all participating and affected title agents that there are two or more transactions on a given property pending at the same time or close to the same time. In this way title agent A can learn that there may be a document that has been or may be recorded by title agent B that may defeat delivery of good and merchantable title at the closing contemplated by title agent A. Any intervening document from these gap periods may affect the title to real estate, yet may be undiscoverable by even a diligent Title Agent until well after the Title Agent's own later title transaction is closed and the potential funds from the transaction have been disbursed.

Conventional mortgage fraud prevention methods, by focusing on the mortgage application process, are unable to address or prevent gap losses. Title insurance companies routinely insure over such gap losses, but such gap related claims are an increasing source of financial loss to underwriters, and problems for innocent purchasers, and the losses from such claim are aggravated by the increasing frequency of cases of deliberate fraud. The mortgage application process is itself only one intermediate step of an entire title transaction and, as discussed throughout herein, a full title transaction may not even include any mortgage or mortgage application. The present invention is an effective tool to reduce gap losses from both the innocent delays, and deliberate fraud schemes that rely upon such delays.

### EXAMPLE NO. 1

### The Case of the Double Sale

Weeks can pass between the filing of a property record and its appearance in computerized registries used by title-search companies. Swindlers take advantage of this gap to engage in what is known as the “double sale.” The swindlers sell a property to one person and, before the sale appears in the recorder's computerized records, the same swindlers sell the property again to a different party. The present invention can identify the double sale at several instances prior to closing the second sale, even if the closing of the first sale has not yet been registered and indexed to appear in a typical title search, by identifying matches in the present database of registered Title Orders.

In this scenario, the Settlement Agent who is hired to run a title search on the first sales transaction will register the Title Order with the database on the website, or other registration system utilized in accordance with the present invention. The Settlement Agent enters specific information relating to the property, as well as information relating to the Seller(s) and Purchaser(s) into the database. This information is catalogued by the processors and/or computers integrated with the database, and then cross-referenced to existing information in the database. If any of the entered information is the same as information in the database, the system sends a notification to the Settlement Agent who registered the information, preferably by email, which notification should include the contact information for all other Settlement Agents dealing with the property. The registering Settlement Agent is then responsible for further investigating the nature of the match.

For the first Title Order registration in this example there should ideally be no matching information identified by the database. However, when the Settlement Agent registering the second sales transaction of this example enters the same property information into the database, a match will be identified. Both Settlement Agents will be sent the email notification discussed above, and both will be responsible for contacting each other to confirm the nature of the copending title transactions on the property. When the Settlement Agents discover that the Seller is attempting to sell the property twice within a short period of time, the fraud is uncovered, and the transactions can be terminated prior to the closings and the issuance of the title policies.

FIG. 4 illustrates an example of a double sale that could be identified by the present invention, but would not be identified by conventional mortgage fraud detection methods and systems, even though both “sales” involve a mortgage application. In this example, the first sale is initiated with both a Title Order and an application for mortgage, often done at the same time. This first sale may successfully close without any indicia of fraud, and the Settlement Agent will report the closing to relevant government agencies in order to have the first title transaction registered and indexed.

During the gap period, however, between the closing of the first title transaction and time it is registered and indexed to appear in title searches, the second sale is initiated, which also involves a mortgage application, and almost always with a different lender. A Title Order for the second sale will not reveal the first sale before it has been registered and indexed. Even a direct link between the lenders and the title company will be of no help in this regard, since the first sale will not yet appear in the computerized registry used by that title company for title searches. A conventional mortgage fraud detection system will also be unable to reveal the double sale because the mortgage application process for the second sale is never simultaneously pending with the mortgage on the first sale, which has already closed. By following all title transactions though, from the first Title Order to at least its eventual registration and indexing, the present invention can successfully combat this type of fraud scheme.

### EXAMPLE NO. 2

### The Case of the HELOC Scam

A HELOC scam occurs when a swindler attempts to obtain a home equity line of credit, or other debt instrument, on a property just prior to selling the property to a bona fide purchaser, and then borrows money on the line of credit. The present invention uncovers the fraud prior to the sale of the property in the same manner as with the “Double Sale,” above. A main difference to the previous example though, is that, in the HELOC scam, the two Settlement Agents will typically be a Title Agent and a loan officer from banking institution (if no title insurance is being obtained by the lender), or simply two Title Agents.

As with the “Double Sale,” both Settlement Agents register the title/loan orders with website database. The relevant information is then catalogued in the database and matching information will be identified. In this example, the property information and the Seller/Owner's name should be the same. Upon identifying the matching information, the system sends email notifications to both Settlement Agents that simultaneous orders are pending on the property. The Settlement Agents would then contact one another and further investigate the nature of the property transactions. When they discover that the Seller is in the process of selling the property at the same time as acquiring a home equity line of credit, the fraud is uncovered, and the Settlement Agents can take the necessary steps to avoid the threatened financial losses.

### EXAMPLE NO. 3

### The Case of the Fraudulent Flip (or Appraisal)

The fraudulent flip occurs when a property is purchased, then falsely appraised at a higher value, and then quickly resold. The fraud is often successful because, by the time the first sales price appears in the public records (after indexing), the property has already been sold a second time (or more) for much more than its actual value. The present invention can identify the fraudulent flip by alerting the Settlement Agents of the copending sales (as defined above). While each of the sales in this example may be legitimate in and of themselves (meaning there is not a “Double Sale” in progress), the sales price of the second sale is what gives rise to the actual fraud.

Among the preferred information entered into the present database by the Settlement Agents, is the sales price for both real estate title transactions. Matches will be identified for the property itself, and for the same type of transaction, but with significantly different sales prices for copending title transactions. This disparity will be identified in the alert sent to the affected Settlement Agents. When the Settlement Agents contact each other to further investigate the copending transactions, they will discover that the sales price on the second transaction is unjustifiably greater than the first transaction, indicating a high possibility of at least a fraudulent appraisal on the second transaction. Having obtained this information prior to the closings, the Settlement Agent for the second transaction can take the necessary steps to avoid the financial loss that would result from the second sale.

### EXAMPLE NO. 4

### The Case of Identity Theft

Another class of fraud schemes stems from identity theft. In these scenarios, the swindler uses personal information from an innocent individual in obtaining a home loan to purchase a property. A sale proceeds, and title to a property passes to the swindler, but in the name of the innocent victim whose identity has been stolen. The swindler then typically uses his or her fraudulent interest in the property to obtain home equity loans (or similar), thereby further leveraging the property, and bringing into the fraud yet another victim, a lender. The swindler usually then “skips town” with the funds from the home equity loan having never made a payment on the original mortgage. The outcome of this fraud generally results in the original mortgagee having to foreclose on the property, which will typically result in a loss to the mortgagee. The identity theft victim will typically have to prove his or her innocence to participation in the fraud, often at a great amount of time and emotional/financial expense. The lender funding the home equity loan will then sustain a loss equal to the entire amount of the loan.

The present invention is able to prevent this type of loss by registering an identity theft alert similar to those used by the three credit bureaus with the database. When the identity theft victim first discovers that his/her identity has been stolen, in addition to contacting the three credit bureaus and relevant law enforcement officials, he/she would preferably also contact the website of the present system and place an identity theft alert on his/her personal information. The alert can be used to flag the identity theft victim's name and personal information when title/loan orders are placed using his/her information. When a title order or loan order is registered with this individual's personal information, email notifications can be sent to all Settlement Agents involved, as well as the identity theft victim. The parties can then confirm whether the identity theft victim is indeed the individual involved in the real estate transactions, and the victim will be spared having to later establish innocence at much greater time and risk.

In all aspects of the present invention, human error is a factor that can prevent information that should match from properly matching in the database. Such errors can be caused by simple typographical errors in the data entry process, or from truncations and/or abbreviations that are inconsistent between records. Accordingly, the present invention may further utilize any of a number of known methods and systems in the database software field of art that predict, anticipate, and or correct for human error to better match records in the database. In yet another preferred embodiment, the present invention utilizes a system known in the art as “fuzzy logic” to more correctly match information that might not otherwise strictly match in the database. The present invention will even more preferably send an alert to a user or subscriber for such near matches that is different from the alert normally sent in accordance with a straight information match. The user may then further investigate whether the near match is an actual match or not.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention.

1. A method of detecting title fraud utilizing an electronic database in which is stored information relating to one or more title transactions, the information including common addresses of real estate properties, and at least one of a type of title transaction relating to the properties, and identifying indicia of parties to the title transactions, the method comprising the steps of:
initiating a title order to a settlement agent for a new title transaction involving settlement services relating to a particular real estate property;
searching said database for at least one other title transaction involving the same particular property, parties, or other indicia in common with said title order or transaction, and for any copendency during a period between said title order initiation and subsequent registration and indexing of said title transaction after said title transaction is completed; and
reporting whether or not a copending title transactions exists and, if so, the nature of, and available information relating to, said copending title transaction.

2. The title fraud detection method of claim 1, further comprising the step of registering said title order with the database and entering the information from said title order and said new title transaction into the database.

3. The title fraud detection method of claim 2, further comprising the step of updating the database regarding any changes or additions to said information from said title order and said new title transaction.

4. The title fraud detection method of claim 3, wherein a confirmation will be sent upon each registration of a title order and upon any update or changes to an existing registration.

5. The title fraud detection method of claim 3, wherein the database is automatically updated upon any update or changes to an existing registration.

6. The title fraud detection method of claim 3, wherein a new database search is performed upon any update or changes to an existing registration.

7. The title fraud detection method of claim 1, wherein said new title transaction is at least one of a cash sale, an easement, a partition or sub-division, articles of agreement, and a loan not secured by said particular property.

8. The title fraud detection method of claim 1, wherein said copending title transaction is at least one of a cash sale, an easement, a partition or sub-division, articles of agreement, and a loan not secured by said particular property.

9. The title fraud detection method of claim 1, wherein said new title transaction additionally involves at least one of a mortgage, a mortgage refinance, a home equity line of credit, a bridge loan, and another type of loan secured by said particular property.

10. The title fraud detection method of claim 1, wherein the stored information further includes at least one of a name of a title agent, a name of an underwriter, a title order number, name of a lender if a particular title transaction involves one or more loans to be secured by real estate, an amount of any loan connected with a title transaction, a property identification number, name and license number of an appraiser of the relevant real estate properties, and a legal description of the relevant properties.

11. The title fraud detection method of claim 1, wherein the party identifying indicia include at least one or more of a party name, Social Security number, drivers license number, residential address, business address, physical description of the party, a photographic image, and a fingerprint.

12. The title fraud detection method of claim 1, wherein each item of identifying information in the database will have its own separate identifier identifying when said item was first registered or ordered.

13. The title fraud detection method of claim 12, wherein a particular item of identifying information in the database can be deleted from the database after the later of said completion of the title transaction and a predetermined time period.

14. The title fraud detection method of claim 13, wherein the predetermined time period is 2 years.

15. A system for detecting title fraud, comprising:
an electronic database storing information relating to one or more title transactions, the information including common addresses of real estate properties, and at least one of a type of title transaction relating to said properties and identifying indicia of parties to the title transactions;
a registration unit registering new title orders or title transactions with said database, and entering information from said new title orders and transactions into the database;
a searching unit capable of searching the database, or information from the database contained elsewhere in the system;
a comparison unit comparing information from a particular title order or title transaction to relevant information obtained by said searching unit from other title orders or transactions;
a reporting unit reporting whether an match occurs between individual items of information from said particular title order or transaction and individual items of information from said other title orders or transactions.

16. The system of claim 15, wherein the said electronic database and said information stored within are accessible over the internet.

17. The system of claim 16, wherein said system is accessible only through password-enabled subscription to a secured website.

18. The system of claim 15, further comprising a timing unit placing a separate identifier on each item of information stored in said electronic database, said separate identifier identifying when each particular item of information was first ordered or registered.

19. The system of claim 18, further comprising a deletion unit deleting specific items of information from said electronic database after the later of a registration and indexing of a particular title transaction to which said specific item of information relates, or 2 years.

20. A computer readable medium storing a program for accessing an electronic database in which is stored information relating to one or more title transactions, the medium including a program executing the steps of:
searching the database, with respect to a particular title order or transaction, for at least one other title transaction involving a same particular real estate property, party, or other indicia in common with said title order or transaction, and for any copendency during a period between an initiation of said title order and subsequent registration and indexing of said title transaction after said title transaction is completed; and
reporting whether or not a copending title transactions exists and, if so, the nature of, and available information relating to, said copending title transaction.
